(19) United States
(12) Patent Application Publication
(10) Pub. No.: US 2007/0097221 A1
(43) Pub. Date: May 3, 2007

(54) Systems and methods of exposure restart for cameras

(76) Inventors: Donald J. Stavely, Windsor, CO (US); Andrew C. Goris, Loveland, CO (US); David K. Campbell, Loveland, CO (US); Gregory V. Hofer, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/261,248

(22) Filed: Oct. 28, 2005

(51) Int. Cl. H04N 5/228

(52) U.S. Cl. 348/208.11

(57) ABSTRACT

Systems and methods for implementing exposure restart in cameras are disclosed. In an exemplary embodiment the method may comprise starting image exposure in response to user input to photograph a scene. The method may also comprise characterizing camera shake based at least in part on motion of the camera. The method may also comprise restarting the image exposure based at least in part on the characterized camera shake.

### TECHNICAL FIELD

The described subject matter relates to cameras in general and more particularly to systems and methods of exposure restart for cameras.

### BACKGROUND

Conventional film and more recently, digital cameras, are widely commercially available. These cameras range both in price and in operation from sophisticated single lens reflex (SLR) cameras used by professional photographers to inexpensive “point-and-shoot” cameras that nearly anyone can use with relative ease. However, the ability to take sharp pictures is limited by the ability of the user to hold the camera steady during image capture. Even professional photographers experience some shaking, e.g., due to breathing and heart-beat.

In conventional film photography (e.g., 35 mm cameras), a sufficiently short exposure time is selected to minimize the impact of camera shake while still providing enough time to adequately capture the image. A general rule of thumb is to limit the exposure time in seconds to no more than one over the focal length. By way of example, where the focal length is 60 mm on a 35 mm camera, the exposure time should be no more than 1/60th of a second. Fast lenses that can provide these short exposure times in available light photography are expensive and bulky.

Longer exposure times may be possible if a tripod is used to steady the camera. However, the use of a tripod is not always convenient or practical, especially for “point-and-shoot” photography.

Active image stabilization is also available for some cameras. In active image stabilization, one of the optical elements (e.g., the lens) is moved in such a way that the image path is deflected in the direction opposite the camera motion. The element is driven by two “voice-coil” type actuators, responding to signals from accelerometers that sense horizontal and vertical motion. However, such systems are complex and expensive to implement.

### SUMMARY

An exemplary embodiment of exposure restart in cameras may be implemented in a system. The system may comprise an image sensor operable to capture an image of a scene being photographed. Exposure timing logic may be provided for characterizing camera shake based at least in part on motion data for the camera, the exposure timing logic restarting exposure of the image by the image sensor based at least in part on the characterized camera shake.

In another exemplary embodiment, exposure restart in cameras may be implemented as a method, comprising: starting image exposure in response to user input to photograph a scene, characterizing camera shake based at least in part on motion of the camera, and restarting the image exposure based at least in part on the characterized camera shake.

### BRIEF DESCRIPTION OF THE DRAWINGS

FIG. 1 is a high-level diagram of an exemplary camera system which may implement exposure restart.

FIG. 2 is a functional block diagram of exemplary exposure timing logic which may be implemented for exposure restart in cameras.

FIG. 3 are plots of exemplary motion data which may be implemented for exposure restart in cameras.

FIG. 4 is a flowchart illustrating exemplary operations which may be implemented for exposure restart in cameras.

### DETAILED DESCRIPTION

Briefly, systems and methods of exposure restart for cameras are disclosed herein. Exemplary systems may include exposure timing logic which receives motion data for the camera before, during, and/or after the image capture operations. The motion data is analyzed, and if the camera is shaking to such an extent that image sharpness will suffer, the exposure may be restarted.

In essence, there is nothing to lose by speculatively starting the exposure when the user depresses the shutter button to take a picture, even if the camera motion at that instant in time is not favorable. The decision to restart the exposure is deferred until a later time. If the camera motion gets worse after the start of the exposure (and thus the original exposure may exhibit less motion blur), the original exposure may still be used for image capture. However, if the camera motion improves after the start of the exposure (and thus starting the exposure later in time may result in an image with less blur), the exposure may be restarted.

Exemplary System

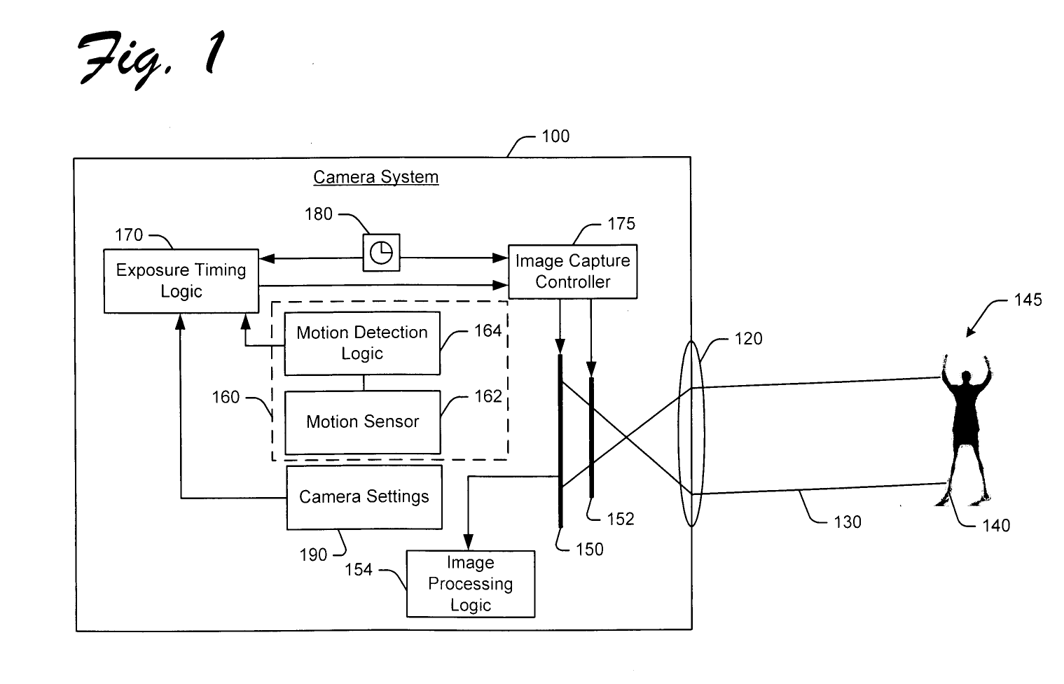

FIG. 1 is a high-level diagram of an exemplary camera system 100 which may implement exposure restart. Camera systems include digital cameras now known or that may be later developed. Exemplary camera system 100 may be provided with logic for characterizing camera motion or shaking, and for restarting the exposure if it is likely to result in a sharper image.

Exemplary camera system 100 may include a lens 120 positioned in the camera system 100 to focus light 130 reflected from one or more objects 140 in a scene 145 onto an image sensor 150 when shutter 152 is open (e.g., for image exposure). Exemplary lens 150 may be any suitable lens which focuses light 130 reflected from the scene 125 onto image sensor 150.

Exemplary image sensor 150 may be implemented as a plurality of photosensitive cells, each of which builds-Lip or accumulates an electrical charge in response to exposure to light. The accumulated electrical charge for any given pixel is proportional to the intensity and duration of the light exposure. Exemplary image sensor 150 may include, but is not limited to, a charge-coupled device (CCD), or a complementary metal oxide semiconductor (CMOS) sensor.

Camera system 100 may also include image processing logic 154. In digital cameras, the image processing logic 154 receives electrical signals from the image sensor 150 representative of the light 130 captured by the image sensor 150 to generate an image.

Shutters, image sensors, and image processing logic, such as those illustrated in FIG. 1, are well-understood in the camera and photography arts. These components may be readily provided for camera system 100 by those having ordinary skill in the art after becoming familiar with the teachings herein, and therefore further description is not necessary.

Camera system 100 may also be provided with a motion tracking subsystem 160 that outputs an indication of the motion of camera system 100 as a function of time. In an exemplary embodiment, motion tracking subsystem 160 may be implemented as a motion sensor 162 and motion detection logic 164.

Motion tracking subsystem may be implemented to measure motion of the camera in any of a variety of ways. For example, the motion sensor 162 may include commercially available accelerometers or gyroscopes that measure pitch and yaw and roll rotational movements. In better keeping with the low cost and complexity objectives of the invention, motion may be measured using the image sensor 150 itself.

Such techniques for measuring motion using the image sensor 150 are well known in the video encoding art. These techniques generally involve comparing at least one picture element (pixel) in a first frame of the video with at least one pixel in a second frame of the video to discern a change in the scene during the interval between the two frames. This process may be repeated for successive pairs of frames to track camera motion relative to the background of the scene in approximately real time. As applied to still cameras, these techniques may be performed on digital preview frames, e.g., as obtained for the video preview mode.

The comparison of pixels may also be implemented in a variety of ways. For example, the magnitude of the pixel-by-pixel difference in brightness (luminance) may be computed. Alternatively, a pixel-by-pixel correlation (multiplication) may be performed. If the pixels compared are in corresponding locations in the two digital preview frames, an indication may be inferred that motion of some sort between the frames occurred but not how much or in what direction. For this reason, these techniques typically also include a search algorithm in which one or more groups of pixels in a first digital preview frame are compared with groups of pixels within a predetermined search region surrounding each corresponding location in a second digital preview frame. The algorithm typically computes a motion vector indicating the magnitude and direction of motion during a particular interval. This motion vector may be expressed as horizontal and vertical motion components.

More sophisticated techniques used in connection with MPEG compression may also be implemented to improve motion measurements. Such improvements may include, for example, a fast search algorithm or an efficient computational scheme in addition to the method described above. Such methods are well known in the video encoding art. One example may be found in U.S. Pat. No. 6,480,629.

Camera system 100 may also include exposure timing logic 170. Exposure timing logic 170 may be operatively associated with the motion tracking subsystem 160. During operation, exposure timing logic 170 receives an indication of the motion of camera system 100 (or camera shake) from the motion tracking subsystem 160 as a function of time, and uses this indication to make a determination whether to restart the exposure.

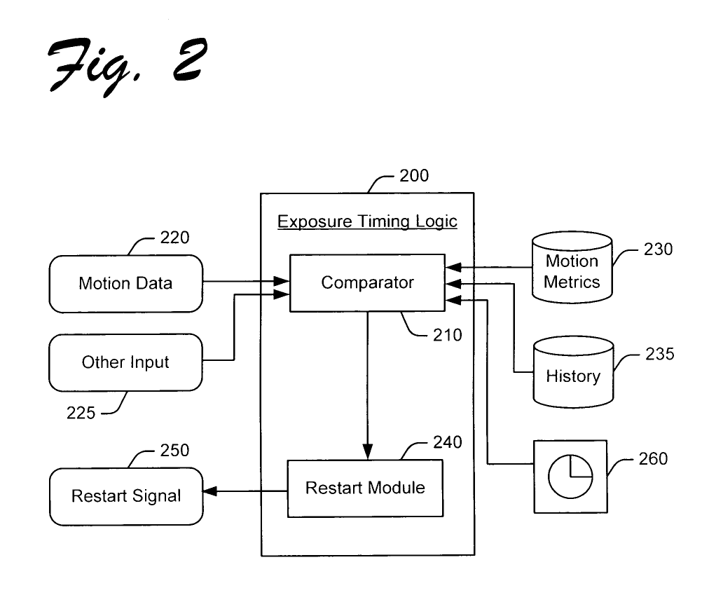

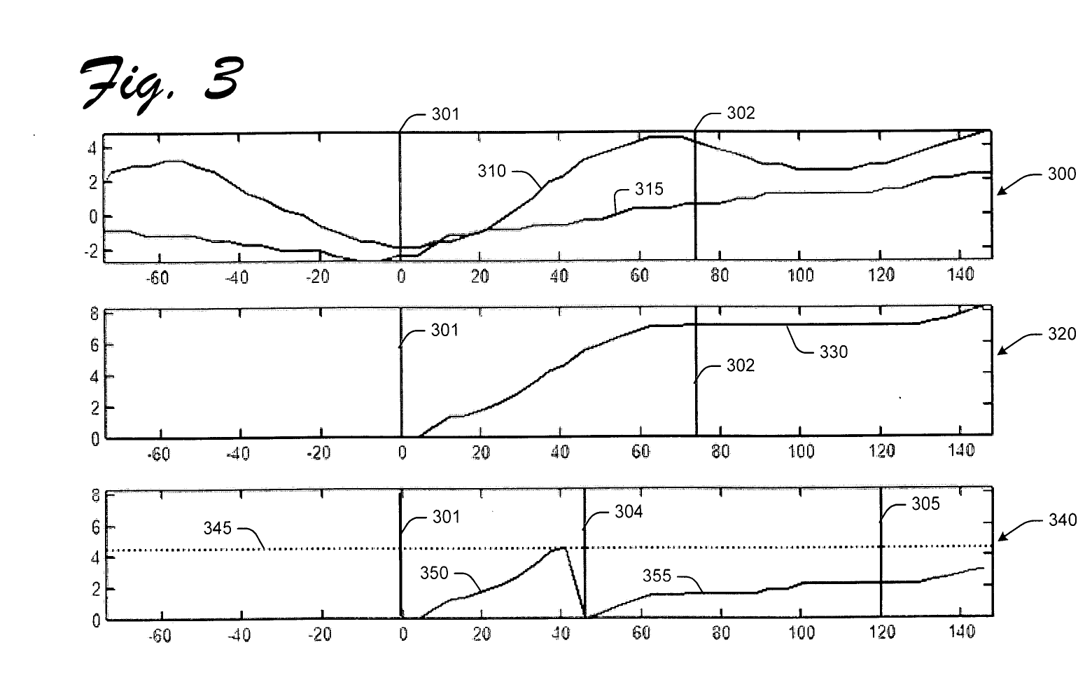

It is noted that the determination whether to restart the exposure may be made according to any of a wide variety of algorithms. In an exemplary embodiment, the exposure timing logic 170 compares the magnitude of the shaking to a threshold value. If the magnitude of the shaking exceeds the threshold value, a determination is made to restart the exposure. Other exemplary implementations for making this determination are explained in more detail below with reference to FIGS. 2 and 3.

If a determination is made to restart the exposure, exposure timing logic 170 may issue a restart signal to image capture controller 175. In response, image capture controller 175 may restart the exposure by flushing the image sensor 150 and resetting the exposure timer (e.g., timer 180). By way of example, the charge that has been accumulated during exposure on a CCD may be “flushed” by pulsing the substrate pin. In another example, a reset transistor may dump accumulated charge to the V_{DD} potential on a complementary metal oxide semiconductor (CMOS) sensor. Other embodiments are also contemplated and may be readily implemented by those having ordinary skill in the art after becoming familiar with the teachings herein.

Exposure timing logic 170 may be operatively associated with a timing device 180. The timing device may be the same timing device 180 provided for other functions in the camera system 100, e.g., for setting exposure time at the image capture controller 175. Alternatively, a separate timing device 180 may be provided for the exposure timing logic 170. In any event, the timing device 180 may be implemented to issue a “time-out” if there is insufficient time left to restart an exposure, thereby terminating or otherwise de-activating the exposure timing logic 170 for a particular image capture operation. Timing device 180 may also be implemented to terminate exposure early, e.g., based on camera shake, user preferences, etc.

Exposure timing logic 170 may also receive input from a camera settings module 190. Camera settings module 190 may include factory-configured and/or user-configured settings for the camera system 100. By way of example, a “motion priority” mode may be set by the user, similarly to “shutter priority” mode and “aperture priority” mode on conventional cameras. Motion priority mode may be implemented, e.g., to automatically activate the exposure timing logic at longer focal lengths or in dark conditions when shutter speed may be slower and therefore more susceptible to blur. These and other camera settings may also be input to the exposure timing logic 170.

Before continuing, it is noted that the camera system 100 shown and described above with reference to FIG. 1 is merely exemplary of a camera system which may implement exposure restart. The systems and methods described herein are not intended to be limited only to use with the camera system 100. Other embodiments of cameras which may implement exposure restart are also contemplated.

FIG. 2 is a functional block diagram of exemplary exposure timing logic 200 which may be implemented for exposure restart in cameras (e.g., as the exposure timing logic 170 for camera system 100 shown in FIG. 1). Exposure timing logic 200 may be implemented to determine whether to restart an exposure and issue an exposure restart signal if the exposure should be restarted.

In an exemplary embodiment, exposure timing logic 200 includes a comparator 210. Comparator 210 receives motion data 220 (e.g., firm the motion detection subsystem 160 described above with reference to FIG. 1). Comparator 210 may also include other input 225, such as, but not limited to, factory-configured and/or user-configured camera settings, a user identity, and other information about the camera (e.g., focal length) and/or scene being photographed (e.g., ambient light levels). The comparator 210 analyzes the motion data 220, and optionally some or all of the other input 225, to determine whether to restart the exposure.

Comparator 210 may base the determination on one or more motion metrics 230. Motion metrics may be stored, e.g., in a data store in long-term and/or short-term memory. Exemplary motion metrics may include temporal (e.g., position, velocity, acceleration of the camera), statistical analysis, frequency domain calculations, and/or any combination thereof.

Comparator 210 may also implement an adaptive algorithm, e.g., basing the determination on prior use or history data 235 of the camera. History data 235 may be stored, e.g., in a data store in long-term and/or short-term memory. Exemplary history data 235 may include camera motion in the time prior to the user depressing the shutter button, or camera motion accumulated during past use (e.g., past hour, day, week, etc.). History data 235 may also include an indicator whether restarting the exposure in various circumstances actually resulted in an improved image.

In an exemplary embodiment, comparator 210 analyzes the motion data 220, and optionally the other input 225, using motion metrics 230 and optionally history data 235 to determine whether the exposure should be restarted. An exemplary algorithm for making an exposure restart determination is described in more detail below with reference to FIG. 3. For now it is sufficient to understand that if the determination is made to restart the exposure, comparator 210 notifies a restart module 240, which in turn issues a restart signal 250, e.g., to the image capture controller to flush the image sensor and reset the exposure tinier. It is noted that the exposure time may be reset at if the exposure is restarted, or the restarted exposure time may be shorter than the original exposure time (e.g., for severe camera shake).

Optionally, the comparator 210 may also receive timing input 260 (e.g., from timer 180 in FIG. 1). Timing input 260 may be implemented to stop the exposure timing logic 200 from issuing a restart signal 250 after a predetermined time, and therefore allow the exposure to finish (and not continue indefinitely). In an exemplary embodiment, timing input 260 may include a time-out that is issued to the comparator 210 to stop operations because there is insufficient time to restart the exposure. Alternatively, the comparator 210 may continue to monitor motion data 220 (e.g., to gather history data 235), but the comparator 210 does not issue a restart signal 250 following the time-out.

It is noted that the time-out may be a constant (e.g., factory pre-set), or based on camera settings (e.g., corresponding to the focal length). Alternatively, the time-out may be adaptable to the user (e.g., the user may override the time-out) and/or the scene (e.g., darker scenes may have longer time-outs). As an illustration, the time-out may vary based on the history of a particular user. For example, the time-out may be shorter for a user who in the past has become increasingly more shaky with time, than for another user who in the past has tended to shake periodically (becoming shaky, then calm, then shaky, etc.). As another illustration, the time-out may vary based on the brightness of the scene (e.g., being longer for darker scenes and shorter for brighter scenes). Of course other design considerations may also be implemented for the time-out, and these examples are not intended to be limiting.

FIG. 3 are plots of exemplary motion data which may be implemented for exposure restart in cameras. Plots 300, 320, and 340 illustrate motion data for times prior to and after starting the exposure (e.g., the user depressing the shutter button at time t=0). Although only motion in the X and Y directions (induced by camera pitch and yaw rotation) is shown in FIG. 3, any type of motion data may be measured, including linear translation and roll rotational movements of the camera.

Plot 300 shows the relative position of a camera in the X-direction (waveform 310) and in the Y-direction (waveform 315) over time (e.g., camera motion or shake). Camera shake is generally periodic, becoming worse at times and better at other times. However, exposure begins when the user depresses the shutter button at time 301 (t=0) regardless of the severity of camera shake. After starting the exposure, camera shake continues to be monitored. If the exposure is allowed to continue without being restarted, it completes about 74 milliseconds (msec) later at time 302. It is observed from plot 300 that during the exposure time (between times 301 and 302) the camera shake is worse than prior to beginning exposure (times t<0) and after ending the exposure (times t>74 msec). Accordingly, restarting the exposure at some time t>0 when camera shake has decreased may result in a better (sharper) image.

Plot 320 shows the overall camera shake (or movement magnitude) over time (waveform 330) based on the relative position of the camera in the X and Y directions from plot 300. The measurement is shown beginning at the original exposure start time t=0 for the case where the exposure is not restarted. It can be seen from plot 320 that the maximum movement magnitude at the end of the exposure time, t=74 msec, has grown to a magnitude of 7 units.

Plot 340 shows overall camera shake (or movement magnitude) over time (waveform 350) accumulating when exposure begins at time 301 (e.g., after the user depresses the shutter button) until the magnitude reaches a threshold 345 approximately 40 msec later at time 303. When the magnitude reaches threshold 350, a determination is made to restart the exposure. It can be seen that at the end of the restarted exposure time, t=120 msec, the maximum movement magnitude has grown to a magnitude of 2 units, a significant improvement over the exposure without restart that was shown in plot 320.

In an exemplary embodiment, exposure timing logic (e.g., the exposure timing logic 200 in FIG. 2) analyzes the motion data to determine whether to restart the exposure, and optionally, to determine a new exposure time. Program code which may be implemented to analyze the maximum position of the magnitude of the camera shake as the exposure progresses is illustrated by the following example:

// Compute max magnitude between all combinations of points
// between exposure time Start and exposure time Current.
idx = expCurrentIndex
maxPosMagnitude(idx) = 0;
startTimeIndex = expBeginIndex;
endTimeIndex = idx;
for i = startTimeIndex + 1 : endTimeIndex

for j = startTimeIndex : i − 1

posMag = ((((x(i) − x(j))\hat{ }2) + ((y(i) − y(j))\hat{ }2))\hat{ }0.5);
if maxPosMagnitude(idx) < posMag

maxPosMagnitude(idx) = posMag;

end//if

end//for

end//for

The exemplary program code determines the maximum position magnitude from the beginning of the exposure to the current position in the exposure. It does this by continuously monitoring all possible magnitude combinations of the X and Y motion data from the beginning of the exposure to the current point in the exposure in real-time. The magnitude between two X-Y points is calculated using the following equation:
M={square root over ((Δx²+Δy²)}
where:
   M is the magnitude of camera shake;
   x is the change in the X direction; and
   y is the change in the Y direction.

When the magnitude (M) meets or exceeds (e.g., “satisfies”) the threshold, the exposure is restarted. The exposure restart is shown in plot 340 at time 304 and occurs before the exposure would have otherwise completed at time 302. Plot 340 also shows the overall magnitude of the camera shake (waveform 355) accumulating after the exposure is restarted at time 304 until the exposure completes 74 msec after the restart at time 305. It is noted that a new exposure time may also be implemented for the restarted exposure (e.g., less than 74 msec for severe camera shake), and is not limited to the same exposure time (e.g., 74 msec).

It is readily observed that the magnitude of camera shake after the exposure is restarted is less than it would have been if the original exposure was allowed to continue to completion. Accordingly, less blur is introduced during the image capture operations and the image is sharper.

It is noted that the exemplary embodiments discussed above are provided for purposes of illustration and are not intended to be limiting. Although the example illustrated in FIG. 3 is based on analyzing motion data in real-time and restarting the exposure if a threshold is satisfied, adaptive data analysis models may be implemented which base the decision at least in part on other data (e.g., a particular user history, camera settings, etc., such as discussed above). In addition, predictive data analysis models may be implemented, wherein the exposure is only reset if the camera shake is improving or predicted to improve. If the camera shake is not improving and/or not predicted to improve, the original exposure may be terminated normally (e.g., at time 302 in FIG. 3) and used to generate the desired image.

Any suitable algorithm(s) may be implemented for determining whether to restart exposure. By way of example, algorithms may be based on periodic lullS in camera shake (e.g., every 10 msec) and therefore image exposure may be restarted periodically after reaching a threshold. In another example, Fast Fourier Transform (FFT), Linear Predictive Coefficient (LPC) filters, and/or any other suitable analysis may be implemented to analyze motion data and determine whether to restart exposure.

It is also noted that different data analysis models may be implemented for different users, under different conditions, and/or for different camera settings. Indeed, multiple different data analysis models may be implemented simultaneously, and the “best fit” selected for making the determination.

Exemplary Operations

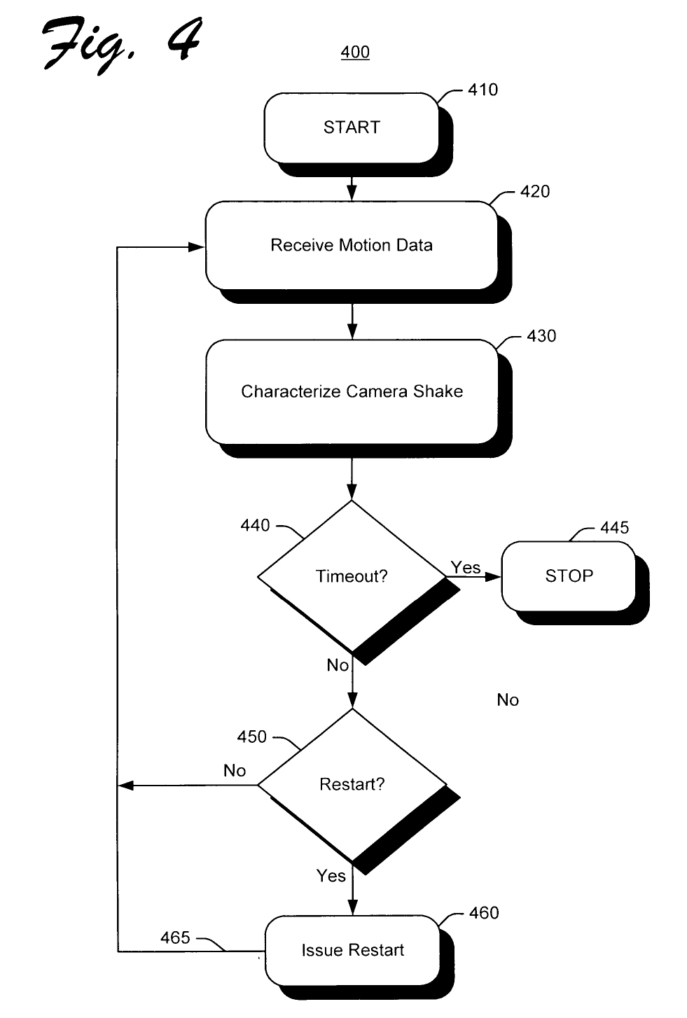

FIG. 4 is a flowchart illustrating exemplary operations which may be implemented for exposure restart in cameras. Operations 400 may be embodied as logic instructions on one or more computer-readable medium in the camera. When executed on a processor at the camera, the logic instructions implement the described operations. In an exemplary embodiment, the components and connections depicted in the figures may be used for exposure restart in cameras.

In operation 410, the exposure restart process begins. For example, the exposure restart process may start every time a user depresses the shutter button to take a picture of an image. Alternatively, the exposure restart process may start after the image has been brought into focus. In still another example, the exposure restart process may start only if one or more predetermined criteria have been satisfied (e.g., the camera is set for a long exposure time, the restart mode is selected by the user, etc.).

It is noted that the exposure restart process may also be deactivated automatically or manually by the user so that the process does not start in operation 410. For example, it may be desirable to deactivate the exposure restart process if the user is photographing a moving subject, or panning a scene. In an exemplary embodiment, the exposure restart process may be automatically deactivated, e.g., by making the exposure timing logic insensitive to smooth motion of the camera and/or based on pre-exposure motion.

In operation 420, motion data is received for the camera. For example, motion data may be received from motion detection logic and/or directly from a motion sensor. In operation 430, the motion data is used to characterize camera shake. Optionally, other data may also be implemented to characterize camera shake for determining whether to restart exposure.

In operation 440, a determination is made whether the process has timed out. For example, the process may time out if the exposure time is over and the image has already been captured. Or the process may time out if there is insufficient time left to restart the exposure (e.g., based on camera settings, scene brightness, etc.). If the process times out, the exposure restart process stops in operation 445.

If the process is not timed-out, in operation 450 a determination is made whether to restart the exposure. In an exemplary embodiment, the determination may be based at least in part on whether a threshold is satisfied. If the threshold is not satisfied, operations may return, e.g., to operation 420 and continue receiving motion data.

The determination may be made to restart exposure if camera shake would negatively affect image sharpness, e.g., based on statistical analysis and/or historical data. If the motion threshold is satisfied, a restart may be issued in operation 460. For example, exposure timing logic may issue a restart signal to an image capture control to flush the image sensor and reset the exposure timer.

It is also noted that the operations 400 may be implemented to restart the exposure more than one time for the same exposure. Such an embodiment is illustrated by arrow 465, which returns to operation 410 after an exposure restart in operation 460.

The operations shown and described herein are provided to illustrate exemplary embodiments of exposure restart in cameras. It is noted that the operations are not limited to the ordering shown. For example, operations 420 and 430 may repeat one or more times before proceeding to the determination operations 440, 450. In another example, determination operations 440, 450 may be executed in reverse order or even simultaneously. In addition, other operations (not shown) are also contemplated. For example, operations may be implemented to reset the exposure time if the exposure is restarted. Or for example, operations may be implemented to determine a new exposure time for the restarted exposure (e.g., shortening exposure time for severe camera shake).

In addition to the specific embodiments explicitly set forth herein, other aspects and embodiments will be apparent to those skilled in the art from consideration of the specification disclosed herein. It is intended that the specification and illustrated embodiments be considered as examples only.

1. An exposure restart system for a camera, comprising:
an image sensor operable to capture an image of a scene being photographed; and
exposure timing logic for characterizing camera shake based at least in part on motion data for the camera, the exposure timing logic restarting exposure of the image by the image sensor based at least in part on the characterized camera shake.

2. The system of claim 1 further comprising a motion detection subsystem inputting the motion data to the exposure timing logic.

3. The system of claim 2 wherein the motion detection subsystem includes a motion sensor for measuring motion data for the camera, and motion detection logic for inputting the motion data to the exposure timing logic.

4. The system of claim 1 further comprising an image capture controller, the image capture controller starting exposure of the image at the image sensor when a user depresses a shutter button.

5. The system of claim 4 wherein the image capture controller restarts exposure of the image based on a restart signal from the exposure timing logic.

6. The system of claim 1 wherein the exposure timing logic characterizes camera shake based at least in part on camera settings.

7. The system of claim 1 wherein the exposure timing logic characterizes camera shake based at least in part on the scene being photographed.

8. The system of claim 1 wherein the exposure timing logic characterizes camera shake based at least in part on historical data.

9. The system of claim 1 wherein exposure of the image is shorter on restart than an original exposure time.

10. The system of claim 1 wherein exposure of the image is not restarted after a time-out.

11. A method of exposure restart for a camera, comprising:
starting image exposure in response to user input to photograph a scene;
characterizing camera shake based at least in part on motion of the camera; and
restarting the image exposure based at least in part on the characterized camera shake.

12. The method of claim 11 wherein characterizing camera shake is based at least in part on at least one of the following: camera settings, the scene being photographed, user data, predictive data, and historical data.

13. The method of claim 11 wherein restarting the image exposure is only prior to a time-out.

14. The method of claim 11 wherein restarting the image exposure is only if camera shake is improving.

15. The method of claim 11 wherein restarting the image exposure is only if camera shake is predicted to improve.

16. The method of claim 11 wherein restarting the image exposure is for a shorter duration.

17. The method of claim 11 wherein characterizing the camera shake is adaptive.

18. The method of claim 11 further comprising clearing the image exposure before restarting the image exposure.

19. The method of claim 11 wherein restarting the image exposure is automatically deactivated if camera motion is expected.

20. A system for restarting exposure in a camera, comprising:
means for starting image exposure of a scene;
means for characterizing camera motion; and
means for restarting image exposure of the scene based at least in part on the camera motion.

21. The system of claim 20 further comprising means for timing the image exposure and deactivating the means for restarting image exposure after a time-out.

22. The system of claim 20 further comprising means for deactivating the means for restarting image exposure if a type of camera motion being characterized is expected.
